(19) United States
(12) Patent Application Publication
(10) Pub. No.: US 2021/0359857 A1
(43) Pub. Date: Nov. 18, 2021

(54) CARD IDENTIFICATION SYSTEM WITH SCRAMBLE CODING ABILITY

(71) Applicant: Shing Kwong Fung, Tsuen Wan (CN)

(72) Inventor: Shing Kwong Fung, Tsuen Wan (CN)

(21) Appl. No.: 16/874,689

(22) Filed: May 15, 2020

(51) Int. Cl. H04L 9/32; G06K 19/06

(52) U.S. Cl. CPC H04L 9/3228; G06K 19/06037; H04L 9/3234

(57) ABSTRACT

A card identification system with scramble coding ability is proposed, in that the card ID, device code and validation period and mobile current time are encrypted and encoded by using a master key and a scrambling variable to form a 2D code. The 2D code is time varied. As a result, the coder receiving end of a decoder must decode and decrypt the 2D code based on the master key and the scrambling variable in a validation period. If the time is over the validation period, a new 2D code is generated at a sending end. If one 2D code is copied, the copied 2D code is only effective in the validation period. Therefore, the system can assure the safety of the identification of a person. The 2D code are usable in various status, such as an employee card, a visitor card, an attendance card.

### FIELD OF THE INVENTION

The present invention is related to identification of an identity of a person by using electronic devices, and in particular to a card identification system with scramble coding ability.

### BACKGROUND OF THE INVENTION

2D codes (such as QR code) serve to store specific information. The QR codes are attached to some objects for identification. Currently, 2D codes are widely used in identification of specific persons, such as using a mobile phone APP to generate a specific 2D code which represent a message about an identify of a user. If the 2D code is scanned by an electronic device, the user may be identified.

In identification of a person, the conventional 2D code has a specific form for a specific person for identification of a person. If this 2D code is copied undesired by another person. Then this person can pass through the identification of this code so that the identification system considers that the another person copied the 2D code 45 is that one which are lawfully authorized. This is not beneficial for control of persons and it is a threatening to the safety of the system.

Therefore, the object of the present invention is to provide a novel card identification system with scramble coding ability so as to resolve the problems of the prior art.

### SUMMARY OF THE INVENTION

Accordingly, for improving above mentioned defects in the prior art, the object of the present invention is to provide a card identification system with scramble coding ability, wherein the present invention provides scrambling 2D codes which are varied with time, that is, it is not unique. If one 2D code 45 is copied, the copied 2D code is only effective in a very short time, such as 10 seconds. Therefore, it can assure the safety of the identification of a person. The 2D code 45 based on the present invention can be used in various status, such as an employee card, a visitor card, an attendance card, etc. The present invention also provides the function of mobile phone identification. The function of decoding can be equipped in a mobile phone so as to prevent that no network is connected.

To achieve above object, the present invention provides a card identification system with scramble coding ability, comprising: a primary terminal for providing data to a mobile phone, the data being about a person to be identified; the primary terminal being owned by an entity; a cloud device connected to the primary terminal for receiving instructions from the primary terminal for transferring at least one identification data set; each identification data set including a card ID, a device code, and a validation period; a mobile phone wirelessly connected to the cloud device; the mobile phone downloading a scrambling coding APP from the cloud device; the scrambling coding APP serving to receive the at least one identification data set transferred from the cloud device and adding a mobile current time from the mobile phone; wherein the scrambling coding APP is built with a scrambling coder and stored at least one master key; each master key being corresponding to a respective identification data set; different identification data set having its own master key; and wherein the scrambling coder is stored with a scrambling variable; the scrambling coding APP encrypts the card ID, the device code, the validation period of the identification data set and the mobile current time based on the master key of the identification data set so as to get an encryption data; then the encryption data is encoded by the scrambling coder by using the scrambling variable to become a 2 dimensional code; due to the action of the scrambling variable, the 2D code is time-varied; that is, the 2D code is only retained for a predetermined time period; after the period, the scrambling coder will generate another 2D code.

The card identification system with scramble coding ability further comprises a coder receiving end for receiving the 2D code from the scrambling coding APP; and a scrambling decoding operator connected to the coder receiving end; the scrambling decoding operator including the scrambling variable or other variables related to the scrambling variable and the at least one master key; wherein for a specific identification data set, the master key of the scrambling decoding operator is identical to the master key of the specific identification data set in the scrambling coding APP; the scrambling decoding operator receives the 2D code from the coder receiving end and decodes the 2D code as a decoded 2D code and then decrypts the decoded 2D code by using the master key so as to get the card ID, the device code, the validation period and the mobile current time corresponding to the identification data set; then the scrambling decoding operator determines whether the current time is in an effective time interval between the mobile current time and the mobile current time plus the validation period; if the current time of decoding is not between the effective time interval, the scrambling decoding operator considers that the time that the coder receiving end scans the mobile phone is over the effective time interval; that is to say, the 2D code is ineffective and then no succeeding operation is performed; if the current time of decoding falls into the effective time interval, then the device code is identified; and if the device code is effective, the card ID is transferred to the cloud device or the primary terminal to inform related members of the entity or to be recorded.

### BRIEF DESCRIPTION OF THE DRAWINGS

FIG. 1 is a block diagram about the element arrangement in one embodiment of the present invention.

FIG. 2 is a block diagram about the element arrangement in another embodiment of the present invention.

FIG. 3 is a block diagram about the element arrangement in a further embodiment of the present invention.

FIG. 4 shows that the current time in decoding is within the period of effective time according to the present invention.

FIG. 5 shows that the current time in decoding is not within the period of effective time according to the present invention.

FIG. 6 shows a first application about the 2D code of the present invention.

FIG. 7 shows a second application about the 2D code of the present invention.

FIG. 8 shows a third application about the 2D code of the present invention.

FIG. 9 shows a fourth application about the 2D code of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

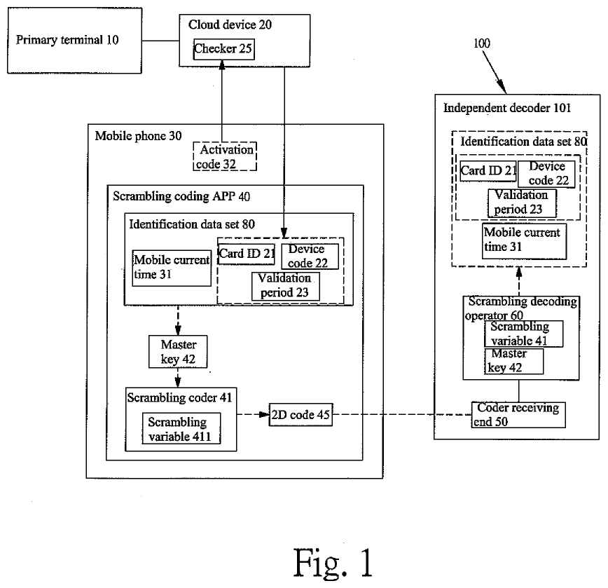

With reference to FIGS. 1 to 9, the system of the present invention is illustrated. The system of the present invention is suitable for various kinds of communication systems, such as 2G, 3G, 4G, 5G, WiFi, blue tooth, NFC, etc. The present invention includes the following elements.

A primary terminal 10 serves to provide data about a person to be identified. The primary terminal 10 is owned by an entity, such as a business entity, a corporation, a school, etc.

A cloud device 20 is connected to the primary terminal 20. The cloud device 20 serves to receive instructions from the primary terminal 10 for transferring at least one identification data set 80. Each identification data set 80 includes a card ID 21, a device code 22, and a validation period 23.

A mobile phone 30 is wirelessly connected to the cloud device 20. The mobile phone 30 could download a scrambling coding APP 40 from the cloud device 20. The scrambling coding APP 40 serves to receive the at least one identification data set 80 (including the card ID 21, the device code 22 and the validation period 23) transferred from the cloud device 20 and adds a mobile current time 31 from the mobile phone 30.

The scrambling coding APP 40 is built with a scrambling coder 41 and at least one master key 42. Each master key 42 is corresponding to a respective identification data set 80. different identification data set 80 has its own master key 42.

The scrambling coder 41 is stored with a scrambling variable 411. The scrambling coding APP 40 encrypts the card ID 21, the device code 22, the validation period 23 of the identification data set 80 and the mobile current time 31 based on the master key 42 of the identification data set 80 so as to get an encryption data. Then encryption data is encoded by the scrambling coder 41 and by using the scrambling variable 411 to become a 2 dimensional code (2D code) 45, such as a QR code. Due to the action of the scrambling variable 411, the 2D code 45 is time-varied. That is, the 2D code 45 is only retained for a predetermined time period. After the period, the scrambling coder 41 will generate another 2D code 45. The predetermined time period is the validation period 23. For example, if the card ID 21 of the identification data set 80 is 01458, the device code 22 is ABC, the validation period 23 is 10 seconds, and the mobile current time 31 of the mobile phone 30 is 120315 (3 minutes and 15 seconds at 12 O'clock). The master key 42 is A01C78; and the scrambling variable 411 is the 120315 (sequential combination of number of hours, minutes and seconds).

The scrambling coding APP 40 encrypts the 01458, ABC, 10 second, and 120315 by using the master key 42 (A01C78). The scrambling coder 41 codes the encrypted data. The coding operation is performed every 10 seconds. The coding is effected by the scrambling variable 411.

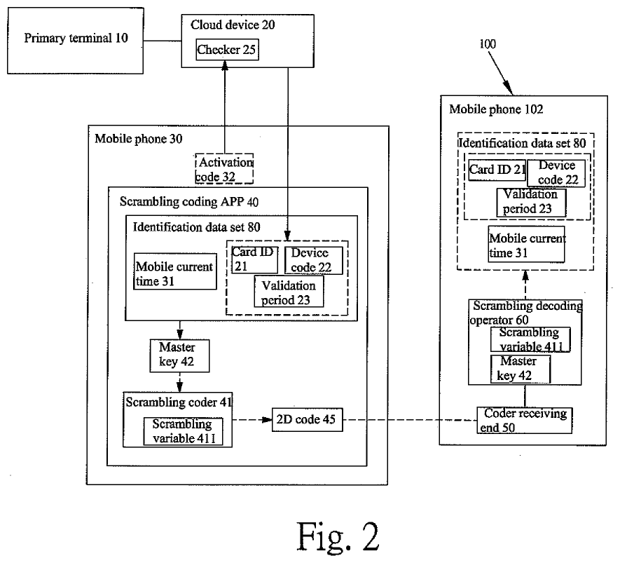

A coder receiving end 50 serves to receive the 2D code 45 from the scrambling coding APP 40. The coder receiving end 50 may be installed in an independent non-clouded electronic device 100, such as an independent decoder 101 (see FIG. 1), another mobile phone 102 (referring to FIG. 2), or other computers of various types,

A scrambling decoding operator 60 is connected to the coder receiving end 50. The scrambling decoding operator 60 includes the scrambling variable 411 or other variables related to the scrambling variable 411 and at least one master key 42. For a specific identification data set 80, the master key 42 of the scrambling decoding operator 60 is identical to the master key 42 of the specific identification data set 80 in the scrambling coding APP 40. The scrambling decoding operator 60 receives the 2D code 45 from the coder receiving end 50 and decodes the 2D code 45 as a decoded 2D code 45 and then decrypts the decoded 2D code 45 by using the master key 42 so as to get the card ID 21, the device code 22, the validation period 23 and the mobile current time 31 corresponding to the identification data set 80.

Then the scrambling decoding operator 60 determines whether the current time is in the effective time interval between the mobile current time 31 and the mobile current time 31 plus the validation period 23. For example, if the validation period 23 is 10 seconds, and the mobile current time 31 is 3 minutes and 15 second of 12 o'clock, that is 120315. Then the scrambling decoding operator 60 determines whether the current time is between 3 minutes and 15 second of 12 o'clock (12:3:15) and 3 minutes and 25 second of 12 o'clock (12:3:25)

With reference to FIG. 5, if the current time of decoding is not between the effective time interval, the scrambling decoding operator 60 considers that the time that the coder receiving end 50 scans the mobile phone 30 is over the effective time interval. That is to say, the 2D code 45 is ineffective and then no succeeding operation is performed.

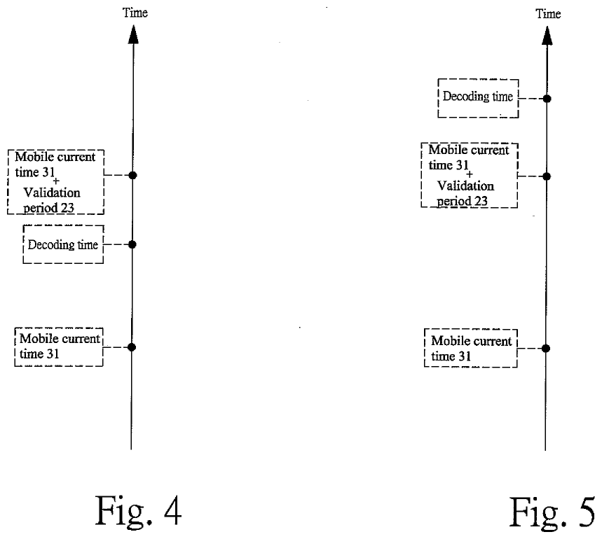

With reference to FIG. 4, if the current time of decoding falls into the effective time interval, then the device code 22 is identified. If the device code 22 is effective, the card ID 21 is transferred to the cloud device 20 or the primary terminal 10 to inform related members of the entity or to be recorded.

In above description, the time of the mobile phone 30 must be synchronous with the time of the coder receiving end 50. This can be achieved easily. It is preferred that the mobile phone 30 and the coder receiving end 50 are connected to a same network system.

The scrambling variable 411 or other variables related to the scrambling variable 411 are variables which are interrelated between the scrambling coder 41 and the scrambling decoding operator 60. That is, the scrambling decoding operator 60 knows the scrambling variable 411 by which the scrambling coder 41 generates the 2D code 45. The scrambling variable 411 may be hour, minutes and seconds or other variables related to time, or variables of other forms.

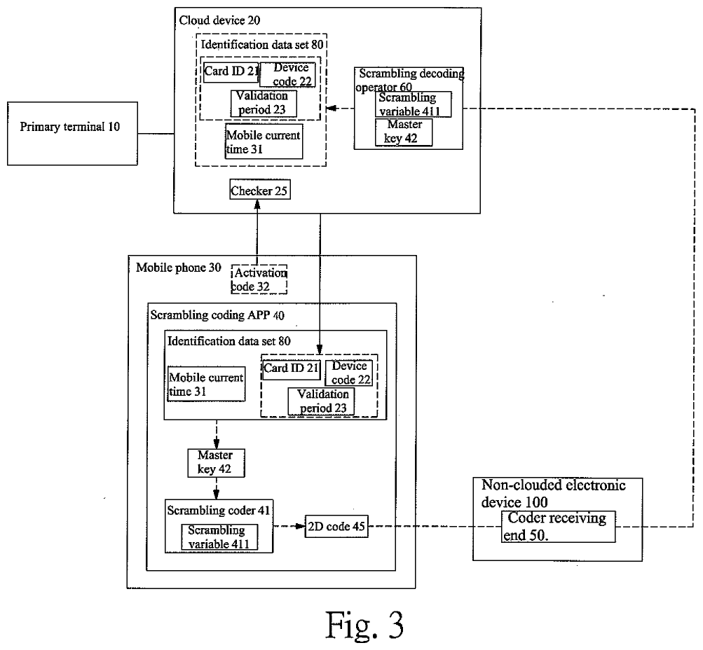

With reference to FIG. 3, the scrambling decoding operator 60 of the present invention may be installed in the cloud device 20 so that it is separated from the coder receiving end 50. The 2D code 45 is transferred to the cloud device 20 through the coder receiving end 50. Next, the scrambling decoding operator 60 decodes the 2D code 45.

Or the scrambling decoding operator 60 is installed in a non-clouded electronic device 100 and is combined with the coder receiving end 50. The non-clouded electronic device 100 is for example, an independent decoder, another mobile phone, or computers of various forms. Under the condition that the scrambling decoding operator 60 is combined with the coder receiving end 50, the non-clouded electronic device 100 may identify the 2D code 45 directly. The objective of this installation is that when no network is used, the non-clouded electronic device 100 can decode and identify directly. Under this condition, the non-clouded electronic device 100 may be connected to the mobile phone 30 through a Bluetooth device. For example, the non-clouded electronic device 100 is another mobile phone (referring to FIG. 2), such as a mobile phone owned by a member of the entity having the primary terminal 10. The member may identify whether the person having the mobile phone 30 is a permissible person by the entity.

The cloud device 20 further includes a checker 25. Before identify, the mobile phone 30 transfers an activation code 32 to the checker 25 of the cloud device 20, the checker 25 will check whether the activation code is an acceptable code by the cloud device 20.

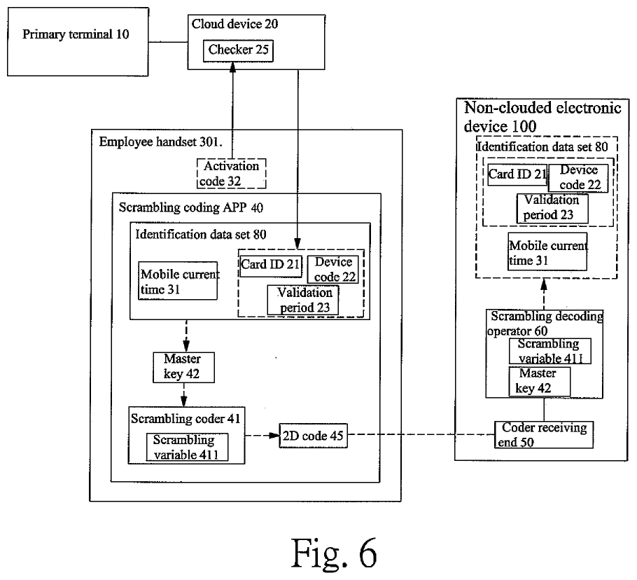

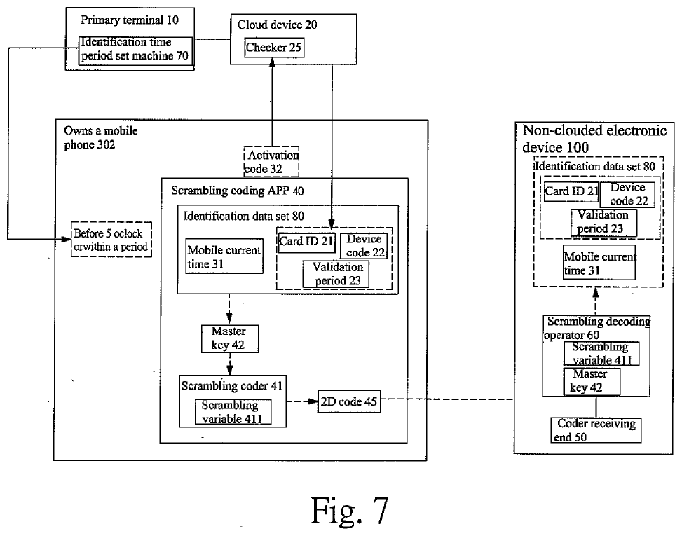

Using a scrambling 2D code as a way for identifying a person according to the present invention may be used in the following applications. With reference to FIG. 6, a first application of the present invention is used to identify an employee identification card. It includes the following processes.

The mobile phone 30 downloads the scrambling coding APP 40. The mobile phone 30 is an employee handset 301.

The primary terminal 10 sends a set of identification data set 80 (including the card ID 21, device code 22 and validation period 23) to the employee handset 301.

The scrambling coding APP 40 adds a mobile current time 31 of the employee handset 301 to the identification data set 80. Then with respect to the master key 42, the scrambling coding APP 40 encrypts the card ID 21, the device code 22 and the validation period 23 of the identification data set 80 and the mobile current time 31 of the employee handset 301 as an encrypted data. Then the encrypted data is coded into a time varied 2D code 45 by the scrambling coder 41 and using the scrambling variable 411. When the employee needs to be identified, the coder receiving end 50 scans the 2D code 45 generated by the scrambling coding APP 40. After the coder receiving end 50 reads the 2D code 45, the scrambling decoding operator 60 decrypts and decodes the 2D code 45 by using the master key 42 and the scrambling variable 411 or other variables related to the scrambling variable 411 into the original card ID 21, device code 22, validation period 23 of the identification data set 80 and the mobile current time 31. Then the scrambling decoding operator 60 determines whether the current time is a time between the “mobile current time 31” and the “mobile current time 31+mobile current time 31”. If yes, the device code 22 is identified to determine whether the device code 22 is a code acceptable by the entity. If yes, the card ID 21 is transferred to the cloud device 20 and the primary terminal 10 so as to make the members of the entity know or recode that the person owning the identification data set 80 is a permissible person.

The present invention further includes an identification time period set machine 70 which is located in the primary terminal 10 or the cloud device 20 for providing a time period which allows the scrambling coding APP 40 to generate the 2D code 45. If the time period is out of the identification time period, the scrambling coding APP 40 does not generate 2D code 45. That is to say, after the identification time period or the identification time, the person owning the mobile phone 30 is not permitted to enter into the entity.

In the following, two examples are provided for description of the identification time period set machine 70.

FIG. 7 shows another application of the present invention. A visitor 30 owns a mobile phone 302. The identification time period set machine 70 sets a time period of 2 hours or an due time of 5 o'clock. Therefore, the scrambling coding APP 40 in the mobile phone 302 generates 2D code 45 only at a time period of 2 hours, or before 5 o'clock. If over the time setting, the visitor is not permitted to enter into the entity.

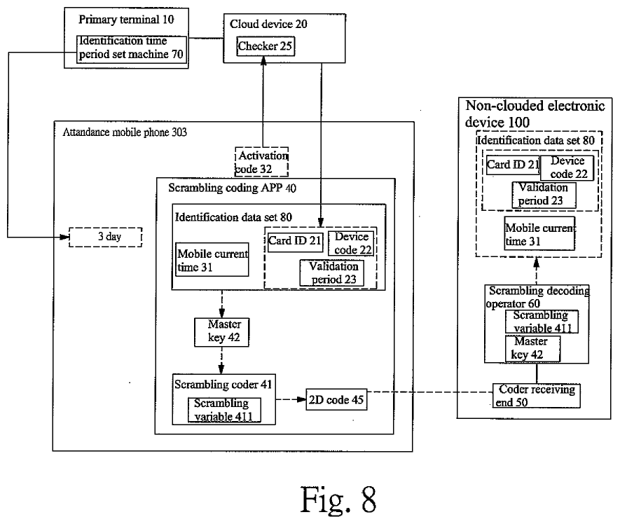

FIG. 8 shows a third application of the present invention. It is shown that the present invention is used to an attendance card for a meeting. In this example, the identification time period set machine 70 can set a time period of 3 days. Therefore, the scrambling coding APP 40 in the mobile phone 302 generates 2D code 45 only at a time period of 3 days. If over the time setting, the scrambling coding APP 40 does not generate the 2D code 45 based on the identification data set 80 and the attendance is not permitted to enter into the entity.

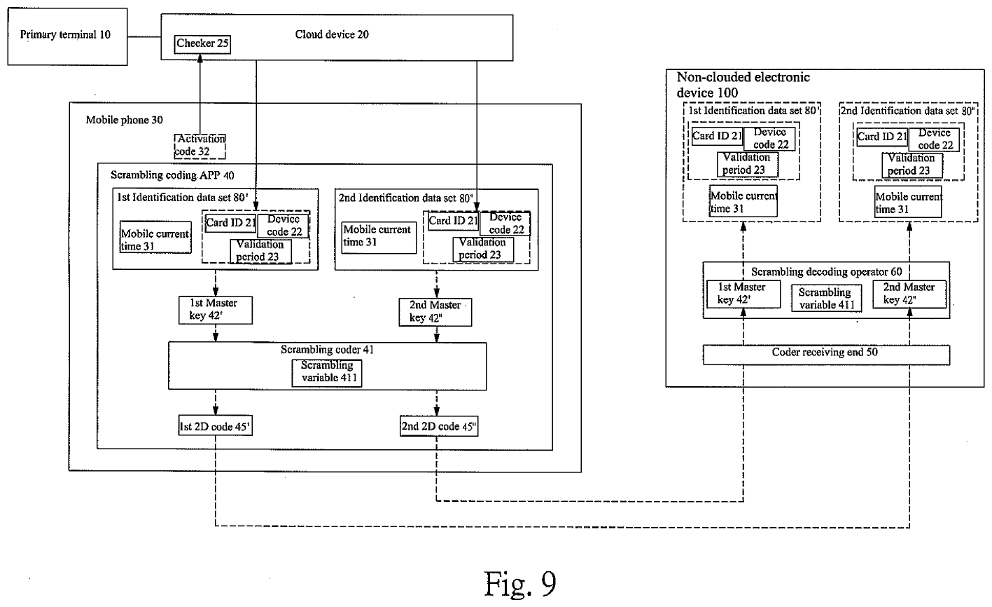

FIG. 9 shows an example that the present invention is used in a case of multiple identification data sets 80. In this application, elements with numerals identical to the above applications mean that they have the same functions. Therefore, the details of these elements are not further described herein. In the following, an example of two identification data sets 80 is used as an example for description.

The identification data sets 80 includes a first identification data set 80′ and a second identification data set 80″. The first identification data set 80′ has a respective master key 42′ and the second identification data set 80″ has a respective master key 42″. The first master key 42′ is not identical to the second master key 42″. After scrambling coding, a first 2D code 45′ and a second 2D code 45″ are generated. In the scrambling decoding operator 60, it uses the first master key 42′ and the master key 42 to decrypt and decode the first 2D code 45′ and uses the second master key 42″ and the master key 42 to decrypt and decode the second 2D code 45″ so as to get the first identification data set 80′ and the second identification data set 80″. Then the scrambling decoding operator 60 determines whether the current time is in the effective times, respectively as the above mentioned way and then the scrambling decoding operator 60 determines whether the device codes of the first identification data set 80′ and the second identification data set 80″ are effective, respectively. The process is identical to the first embodiment, while each identification data set 80 has its master key 42.

When there are a plurality of identification data sets 80, there may be a plurality of coder receiving ends 50. Each coder receiving end 50 has a respective identification data set 80. For example, an entity has a plurality of departments, and each department has its own coder receiving end 50. Each coder receiving end 50 can identify one of the 2D codes 45 so as to determine whether the person having the 2D codes 45 can enter into the department.

Advantages of the present invention are that the present invention provides scrambling 2D codes which are varied with time, that is, it is not unique. If one 2D code 45 is copied, the copied 2D code is only effective in a very short time, such as 10 seconds. Therefore, it can assure the safety of the identification of a person. The 2D code 45 based on the present invention can be used in various status, such as an employee card, a visitor card, an attendance card, etc. The present invention also provides the function of mobile phone identification. The function of decoding can be equipped in a mobile phone so as to prevent that no network is connected.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A card identification system with scramble coding ability, comprising:
a primary terminal for providing data to a mobile phone, the data being about a person to be identified; the primary terminal being owned by an entity;
a cloud device connected to the primary terminal for receiving instructions from the primary terminal for transferring at least one identification data set; each identification data set including a card ID, a device code, and a validation period;
a mobile phone wirelessly connected to the cloud device; the mobile phone downloading a scrambling coding APP from the cloud device; the scrambling coding APP serving to receive the at least one identification data set transferred from the cloud device and adding a mobile current time from the mobile phone;
wherein the scrambling coding APP is built with a scrambling coder and stored at least one master key; each master key being corresponding to a respective identification data set; different identification data set having its own master key; and
wherein the scrambling coder is stored with a scrambling variable; the scrambling coding APP encrypts the card ID, the device code, the validation period of the identification data set and the mobile current time based on the master key of the identification data set so as to get an encryption data; then the encryption data is encoded by the scrambling coder by using the scrambling variable to become a 2 dimensional code; due to the action of the scrambling variable, the 2D code is time-varied; that is, the 2D code is only retained for a predetermined time period; after the period, the scrambling coder will generate another 2D code.

2. The card identification system with scramble coding ability as claimed in claim 1, further comprising
a coder receiving end for receiving the 2D code from the scrambling coding APP; and
a scrambling decoding operator connected to the coder receiving end; the scrambling decoding operator including the scrambling variable or other variables related to the scrambling variable and the at least one master key;
wherein for a specific identification data set, the master key of the scrambling decoding operator is identical to the master key of the specific identification data set in the scrambling coding APP; the scrambling decoding operator receives the 2D code from the coder receiving end and decodes the 2D code as a decoded 2D code and then decrypts the decoded 2D code by using the master key so as to get the card ID, the device code, the validation period and the mobile current time corresponding to the identification data set;
then the scrambling decoding operator determines whether the current time is in an effective time interval between the mobile current time and the mobile current time plus the validation period; if the current time of decoding is not between the effective time interval, the scrambling decoding operator considers that the time that the coder receiving end scans the mobile phone is over the effective time interval; that is to say, the 2D code is ineffective and then no succeeding operation is performed; if the current time of decoding falls into the effective time interval, then the device code is identified; and if the device code is effective, the card ID is transferred to the cloud device or the primary terminal to inform related members of the entity or to be recorded.

3. The card identification system with scramble coding ability as claimed in claim 2, wherein the time of the mobile phone is synchronous with the time of the coder receiving end.

4. The card identification system with scramble coding ability as claimed in claim 2, wherein the scrambling variable or other variables related to the scrambling variable are variables which are interrelated between the scrambling coder and the scrambling decoding operator; that is, the scrambling decoding operator knows the scrambling variable by which the scrambling coder generates the 2D code.

5. The card identification system with scramble coding ability as claimed in claim 2, wherein the scrambling variable is hour, minutes and seconds.

6. The card identification system with scramble coding ability as claimed in claim 2, wherein the scrambling variable is related to time.

7. The card identification system with scramble coding ability as claimed in claim 2, wherein the predetermined time period is the validation period.

8. The card identification system with scramble coding ability as claimed in claim 2, further comprising an identification time period set machine which is located in the primary terminal or the cloud device for providing a time period or a time which allows the scrambling coding APP to generate the 2D code; if the time period is out of the identification time period or the time, the scrambling coding APP does not generate 2D code.

9. The card identification system with scramble coding ability as claimed in claim 2, wherein the scrambling decoding operator is installed in a non-clouded electronic device.

10. The card identification system with scramble coding ability as claimed in claim 8, wherein the non-clouded electronic device is an independent decoder or another mobile phone, so that the non-clouded electronic device can identify the 2D code directly.

11. The card identification system with scramble coding ability as claimed in claim 8, wherein the scrambling decoding operator is installed in the cloud device so that it is separated from the coder receiving end; the 2D code is transferred to the cloud device through the coder receiving end; then the scrambling decoding operator decodes the 2D code.

12. The card identification system with scramble coding ability as claimed in claim 8, wherein the scrambling decoding operator is installed in a non-cloud device so s to be combined with the coder receiving end.

13. The card identification system with scramble coding ability as claimed in claim 1, wherein the system is applied to one of communication systems of 2G, 3G, 4G, 5G, WiFi, blue tooth and NFC.

14. The card identification system with scramble coding ability as claimed in claim 2, wherein the 2D code is QR code.

15. The card identification system with scramble coding ability as claimed in claim 2, wherein the cloud device includes a checker; before transferring the identification data set, the mobile phone transfers an activation code to the checker of the cloud device, the checker will check whether the activation code is an acceptable code by the system.

16. The card identification system with scramble coding ability as claimed in claim 2, wherein the at least one identification data sets are a plurality of identification data sets; each identification data set has its own related master key; and the scrambling coding APP encrypts and encode each identification data set by using the master key which is related to the identification data set and the scrambling variable; and the scrambling decoding operator decoding and decrypting the 2D code by using the scrambling variable or other variable related to the scrambling variable and the master key related to the identification data set.

17. The card identification system with scramble coding ability as claimed in claim 15, wherein when there are a plurality of identification data sets, there are a plurality of coder receiving ends; and each coder receiving end has a respective identification data set.
